(19) United States
(12) Patent Application Publication
(10) Pub. No.: US 2026/0161460 A1
(43) Pub. Date: Jun. 11, 2026

(54) DISTRIBUTED AND MULTILABEL WORKLOAD PLACEMENT APPROACH BASED ON INFRASTRUCTURE GRAPH SEARCH

(71) Applicant: Dell Products L.P., Round Rock, TX (US)

(72) Inventors: Diego Vrague Noble, Pelotas (BR); Eduardo Vera Sousa, Niterói (BR); Karen Braga Enes, Belo Horizonte (BR); Karen Stéfany Martins Zuin, Belo Horizonte (BR)

(21) Appl. No.: 18/970,708

(22) Filed: Dec. 5, 2024

(51) Int. Cl. G06F 9/50

(52) U.S. Cl. CPC G06F 9/5027

(57) ABSTRACT

One example method includes receiving an initial batch of elements, building a priority queue for the elements, building a graph that represents a network, and the graph comprises nodes, and edges connecting the nodes, using a seed set of nodes of the graph as an initial visible set of nodes, and the seed set is a subset of all nodes of the graph, and so long as elements remain in the priority queue and/or a query budget has not been exhausted, attributing the elements to the nodes of the graph.

### COPYRIGHT AND MASK WORK NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to workload placement in a network. More particularly, at least some embodiments relate to systems, hardware, software, computer-readable media, and methods, for distributed and multilabel workload placement approach based on infrastructure graph search.

### BACKGROUND

Search in graphs refers to the process of traversing a graph, a subgraph, or a set of interconnected nodes to find one or more specific node or path. Graph search refers to a class of algorithms that systematically explore the nodes and edges of a graph, computing various properties. The nodes of a graph may represent respective network entities, while edges connecting the nodes indicate a relationship between the connected nodes. A graph may be used to inform placement of workloads, such as computing workloads, at one or more of the network entities.

In many real-world networks, searching in a graph or accessing data associated with nodes and edges of the network is often difficult and querying nodes can have a steep cost. In these scenarios, it is often the case that a large fraction of the data that is to be modeled is unobserved, and only a limited budget may be available to perform queries to identify nodes of interest. Moreover, a searcher may not be interested in the complete network, but only in a set of target nodes, such as nodes with particular characteristics.

The problem of finding the largest number of target nodes for partially unknown networks topologies under a query budget constraint is called Selective Harvesting (SH). SH can be stated as a graph search problem on a partially unobserved network topology. In such a problem, a searcher has only a partial view of the entire network and, further, is limited to performance of a specified number of queries to uncover the nodes of interest in the network. The search must be intelligently guided so as not to waste queries in unpropitious network regions.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of the operation of a generic algorithm that solves an SH search problem, according to one embodiment.

FIG. 2 discloses aspects of an initial network graph, and associated process, with a priority queue, and a query budget, according to one embodiment.

FIG. 3 discloses aspects of a process for attribution of elements to nodes of a graph, according to one embodiment.

FIG. 4 discloses a subsequent application of the SH algorithm applied in the example of FIG. 3.

FIG. 5 discloses aspects of an initial network graph, and associated process, with multi-label nodes and composite elements, along with a priority queue, and a query budget, according to one embodiment.

FIG. 6 discloses aspects of an a ‘bucket variation’ of an initial network graph, and associated process, with multi-label nodes and composite elements, along with a priority queue, and a query budget, according to an embodiment.

FIG. 7 discloses a partially observable network crawled by multiple, independent, HS crawlers, according to one embodiment.

FIG. 8 discloses aspects of a computing entity configured and operable to perform any of this disclosed methods, processes, and operations.

### DETAILED DESCRIPTION OF SOME EXAMPLE EMBODIMENTS

Embodiments disclosed herein generally relate to workload placement in a network. More particularly, at least some embodiments relate to systems, hardware, software, computer-readable media, and methods, for a distributed and multilabel workload placement approach based on infrastructure graph search.

In general, example embodiments comprise methods and/or architectures for constructing and/or searching a graph that includes nodes and edges. In one, non-limiting, embodiment, each node represents an entity in a network, and the edges represent, among other things, relationships between nodes connected, in the graph, by the edges. One possible application of a method according to one embodiment comprises searching a graph to identify one or more nodes capable of executing a workload, or workloads. As such, a node may, in an embodiment, represent a computing entity and/or computing resources including, but not limited to CPU, storage, and/or memory, and/or any other resources usable to execute a computing workload. This is but an in illustrative example, and the scope of this disclosure and any claims is not limited to the example of workload placement.

One such method according to an example embodiment may comprise various operations including, for example: receiving an initial batch of elements; building a priority queue for the elements of the batch; building a graph-based representation of a network; using a seed set of nodes of the graph as an initial visible set of nodes; using the seed set of nodes to build a border set of nodes; and, attributing elements to the nodes of the graph, so long as elements remain in the priority queue and/or query budget remains. Depending upon an outcome of the attributing operation, all of the elements may, or may not, be attributed to one of the nodes of the graph. In an embodiment, one or more SH algorithms may be applied to the graph-based representation of the network to facilitate attribution of the elements to nodes of the network.

Following is a brief discussion of some terms used in this disclosure. By way of illustration, and not limitation, an “element” as used herein, that may be assigned to a node, may comprise a workload, such as a computing workload for example. As such, a “priority queue” may specify relative priorities of various workloads relative to each other by listing the elements in a particular order, and a priority queue may be determined by the domain of a particular application. To continue with this example, a “label” as used herein may refer, for example, to a particular computing capability, feature, or device, of a node. As such, a node may be associated with one or more labels that collectively specify the capabilities of that node, and which can be used to determine whether or not an element, such as a workload, will be placed at that node.

Moreover, and with reference to some further examples, the definition of an element may depend on the application domain. For example, in an edge device domain, an element could be a sensor, thus a set of elements represents a set of different sensors. The label for these elements will identify, for example, the type of each sensor; it could be a temperature, movement, speed, an altitude sensor, among others. The same sensor can be of more than one type and, therefore, have more than one label. For example, the same sensor that measures temperature can also measure humidity. Consider, for instance, a sensor A that measures temperature and humidity. In this case, sensor A is an element with two different labels, “Temperature” and “Humidity.” To model a problem as partially observed graph, all nodes have one label associated with it and at least one element. Thus, sensor A would be attribute to the node with label “Temperature” and would also be attribute to the node with label “Humidity.”

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiments is that multiple different labels may be found in a partially observable graph that represents a portion of a network. An embodiment may employ multiple SH engines, possibly operating simultaneously, to identify various different labels in nodes of a partially observable graph. An embodiment may identify nodes capable of executing a computing workload. Various other advantages of one or more example embodiments will be apparent from this disclosure.

### A. References

Reference is made herein to various documents. These documents, listed immediately below, are incorporated herein in their respective entireties by this reference.
[1] F. Murai, D. Rennó, B. Ribeiro, G. Pappa, D. Towsley and K. Gile, “Selective harvesting over networks,” Data Mining and Knowledge Discovery, no. 32, pp. 187-217, 2018.
[2] C. Wang, K. C.-C. Chang, P. Wang, T. Qin and X. Guan, “Heterogeneous Network Crawling: Reaching Target Nodes by Motif-Guided Navigation,” IEEE Transactions on Knowledge and Data Engineering, vol. 34,no. 9, pp. 4285-4297, 2022.
[3] De Lange, Matthias, et al., A continual learning survey: Defying forgetting in classification tasks, IEEE transactions on pattern analysis and machine intelligence 44.7, 2021.
[4] U.S. patent application Ser. No. 18/491,987 , titled “Motif-Based Subgraph Matching in Partially Observed Graphs”, and Filed October 23, 2023.

### B. Aspects of An Example Context for One or More Embodiments

The following is a discussion of aspects of an example context for one or more embodiments. This discussion is not intended to limit the scope of the claims or this disclosure, or the applicability of the embodiments, in any way.

### B.1 Graphs

Graphs are mathematical structures used mainly to represent relationships (edges) between entities (vertices or nodes). These structures can be used to model many problems. In many of these applications, the vertices, or nodes, of a graph can contain valuable information about the entities being modeled on these structures. This set of information about the modeled entities is referred to as the attributes of the nodes. In addition, the vertices, that is, the nodes, of a graph may have special characteristics, which may be referred to herein as ‘labels,’ which make those nodes the target for performance of certain tasks, for example.

### B.2 Search in Graphs

Search in graphs refers to the process of traversing a graph, a subgraph, or a set of interconnected nodes, in order to find one or more specific node(s) or path(s). Graph search refers to a class of algorithms that systematically explore the nodes and edges of a graph, computing many interesting properties.

In many real networks, searching in a graph or accessing data associated with nodes and edges of the network is often difficult, and querying nodes can have a steep cost in terms of time, and computing resources consumed. In these scenarios, it is often the case that a large fraction of the data to be modeled is unobserved, and there may only be a limited budget available to perform queries. Such a budget may be expressed, for example, in terms of a number of queries that can be performed, time, computing resources, financial cost, and/or in terms of other bases. Moreover, some applications may not be interested in the complete network, but only in a set of target nodes, that is, nodes with certain characteristics, that comprises a subset of all the nodes of the complete network.

As an example, consider the problem of finding as many Facebook® users that share a particular taste in music as possible, starting from a friendship network of a specific user. In this illustrative example, the Facebook® users are nodes, friendship status is indicated by the edges, and musical tastes are user attributes, or labels. Except for the Facebook® engineers themselves, however, access to the network is limited and it is impossible, at least as a practical matter, to query all nodes.

### B.3 Selective Harvesting

As noted above, the problem of finding the largest number of target nodes for partially unknown networks topologies under a query budget constraint is called Selective Harvesting. See [1]. SH can be stated as a graph search problem on a partially unobserved network topology. However, due to the inherent complexity of the addressed problem, it can be framed from other perspectives, such as an unbalanced data classification problem, a reinforcement learning task or as an anomaly detection problem, to enumerate a few.

In SH, data is acquired through an online search or exploration of the graph, which can be seen as an evolving process that increases knowledge about the network as the search expands. At each stage, structural and non-structural information regarding topology, nodes and edges'data is acquired. Since the networks are partially unobserved in SH, the set of queried nodes and their connections to the rest of the network together compose all available information about the network.

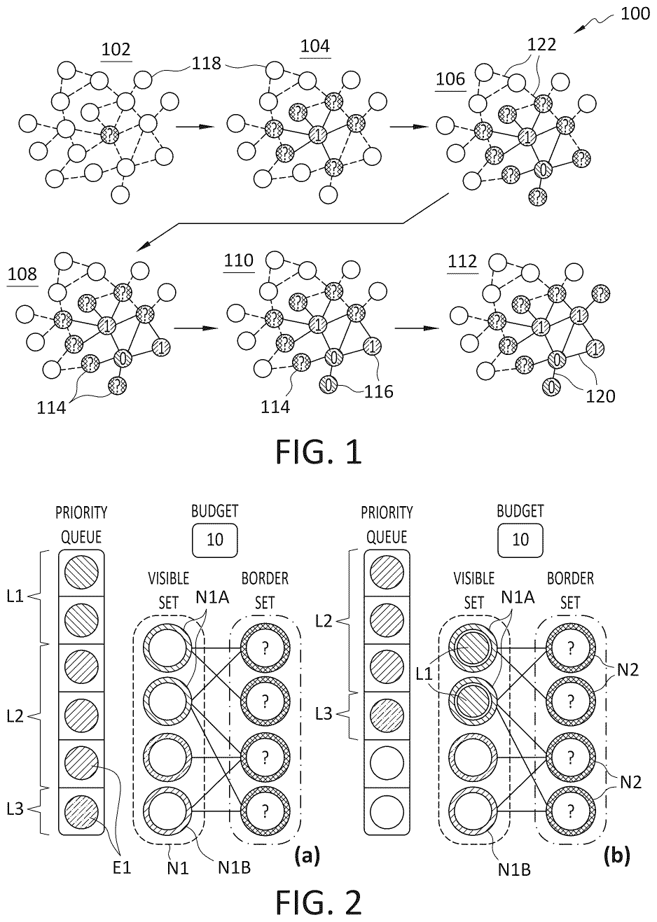

Any algorithm that solves SH presents itself as a solution for a search problem into partially observed graphs. The main difference between these methods is how they choose which node to explore next. The example progression 100 disclosed in FIG. 1 illustrates 5 consecutive stages 102, 104, 106, 108, 110, and 112, of an algorithm that performs an SH search procedure.

More particularly, the black, gray, and white colors represent visible, border, and unknown, nodes respectively. Border nodes, that is, nodes that can be seen but remain unqueried, are candidate nodes to be queried because they border with at least one visible (queried) node. Nodes that have no connections to queried nodes are unknown until they get at the border. In particular, unqueried nodes 114 are candidate nodes to be queried because they border with at least one queried node 116. Nodes 118 that have no connections to queried nodes 116 are unknown until they get at the border and, thus, become unqueried 114. Solid 120 and dashed 122 lines represent known and unknown edges, respectively. Further, “1” indicates target nodes and “0 ” indicates non-target nodes. Nodes marked with “?” indicate an unknown label.

### C. Overview of Aspects of an Example Embodiment

### C.1 Introduction

One or more embodiments are directed to a scenario of the harvesting problem where there is a defined number of labels, and each node and element have a specific label. Thus, an embodiment comprises a version of SH that considers the problem of searching in a distributed multi-label scenario. An embodiment may receive a batch of elements with its respective labels and attribute these elements to nodes that share the same label, therefore, this approach must search for multiple target labels in a partially unknown network and at the same time attribute elements to them. This, then, is a variation of a problem that has applications in workload placement or social network analysis, to name but a few example applications of one or more embodiments.

### C.2 Discussion

One or more embodiments comprise an approach for solving a variation of the Selective Harvesting (SH) problem in which the graph search aim is to discover the highest number of nodes that have certain labels. In the canonical SH problem, the aim is to uncover the largest number of nodes that have the target label, while remaining within a limited query budget. Additionally, the network is only partially visible, that is, there is no global view of the whole network but just a part of queried and therefore visible nodes, this is the visible set of nodes. The set of visible, but not queried, nodes is the border set of nodes and an embodiment may select one node at a time from the border set to query that nodes and reveal its label. For each border node, we apply the SH on its features to predict the probability of this node to be a target. In the canonical case, and by way of contrast with one or more embodiments, there are two outcomes only: the node either has the target label, or it does not. This process is repeated while the query budget is still available. The problem variation, to which one or more example embodiments are directed, departs from this modeling because, for example, an embodiment receives batches of elements and aims to, and does, attribute elements to nodes that share the same label. Thus, an embodiment searches for multiple target labels and, at the same time, attributes elements to those target labels.

Before describing an example embodiment, the following assumptions concerning a simple version of a problem to which an embodiment may be directed, and concerning the environment, are considered:
1. The network can be modelled as an undirected graph G and it is partially observable, that is, there is only a limited view of graph;
2. The graph is highly dynamic—thus, it may be necessary to repeat the process because the graph may change from time to time;
3. There is a set of labels L={l₁, . . . , lₙ}, each label represents a possible class which can be tweet topics, device types, etc. depending on the problem domain;
4. Each node v of G has a vₗ∈Llabel;
5. The input I={e₁, . . . , eₘ} is a batch of elements, and each element e has a label associated;
6. There is a seed set of neighbor nodes from which the SH will cold start;
7. For each label l∈L, there will be a respective SH algorithm instance, or model, totaling n models;
8. There is a global query budget b>0 that is associated with the whole batch;
9. Elements may have a priority value associated, for simplicity, this may be assumed to be a numerical value and the lower the value is, the higher the priority of this workload—if two or more workloads have the same priority, a random choice may be used as a tie breaker for simplicity;
10. An embodiment may assume that the batch is represented using a priority queue PQ data structure for simplicity and efficiency—additionally, consecutive, and highest priority elements with the same label will be extract at once;
11. Nodes can have at most one element attributed to them; and
12. Each label l has a respective SHₗ algorithm instance which is trained to seek and query nodes with that label l.

Given these assumptions, one example embodiment comprises a method that includes the following operations:
1. Receive an initial batch I with at least one element,
2. Build the priority queue PQ from batch I,
3. Receive the network and build the graph-based representation,
4. Given the seed set, use the seed set as the initial visible set,
5. Build the border set from the seed set,
6. While there are elements in PQ:
   a. Extract the element or elements with the same label l with the highest priority from the queue,
   b. Verify if all the extracted elements can be placed in nodes on the visible set,
      i. If yes, attribute the elements to the available nodes,
      ii. If no, but there is budget available,
         1. Apply the SHₗ,
         2. Update the visible set,
         3. Update the border set,
         4. Reduce the budget by 1 unit,
         5. Go to 6.b,
      iii. If there is no more budget available and there is at least an extracted element without a node to be attributed to,
         1. Halt in failure,
7. Halt in success.

### C.3 Conclusion

As discussed above, one embodiment comprises an architectural configuration and approach that that integrates multiple adapted algorithms in a complex task, and it may include various aspects, examples of which are set forth hereafter. It is noted that no embodiment is required to possess any of these aspects however.

For example, an embodiment may comprise a multi-label SH approach to search on a partially observed graph based. This approach departs from a conventional binary classification that SH is usually associated with. In the classical, that is, conventional, SH approach, nodes each have a binary label, and the search is performed to uncover the target label. By way of contrast with this conventional approach, an embodiment may employ, possibly simultaneously, many SH algorithm instances, each of which may be trained specifically to search for its, or a particular, label. When combined, the SH algorithm instances search in turns for multiple different labels. This differs from naïve and trivial approaches such random search. Moreover, a greedy approach is impossible to implement as labels from the border set, that is, the set of visible but unqueried nodes, are hidden. For a given batch, all instances share the same budget and queried set and can have historical data stored to speed up the warmup of SH algorithms.

As another example, an embodiment may comprise a distributed SH approach to search on a partially observed graph based. Such an embodiment may differ from the conventional SH approach which is executed as a single process of sequential queries. That is, a method according to one embodiment enables semi-independent crawlers to search over the same network, that is, the same group of nodes. This feature may be particularly useful when tackling searches on huge networks geographically distributed in multiple continents. Additionally, by sharing information about the border and the visible set, each crawler can maximize its potential search success rate.

Thus, in contrast with conventional approaches, one or more embodiments may implement multiple SH algorithms. As well, an embodiment may be capable of finding multiple labels in a partially observable network in a distributed architecture.

### D. Detailed Discussion of Aspects of One or More Example Embodiments

Following is a more detailed description of aspects of an embodiment. While embodiments may be usefully applied in large and complex environments and circumstances, in the interest of simplifying the discussion, reference will be made to a sequence of depictions that illustrate a hypothetical simple version of the algorithm, followed by a discussion of how an embodiment may then be applied to more complex scenarios.

In one example embodiment of a multilabel SH scenario, described earlier herein, some parameters used by an algorithm according to one embodiment include a priority queue with six elements, a query budget of ten, and a simple graph with four visible nodes and four border nodes. For simplicity, it may be assumed that the initial network graph is available, that is, there may be no need to build a visible set of nodes, or a border set of nodes. Without loss of generality, it may also be assumed, for the purposes of this illustrative example, that there are only eight nodes, and all of them are available, as is are the respective SH algorithm instances for each label.

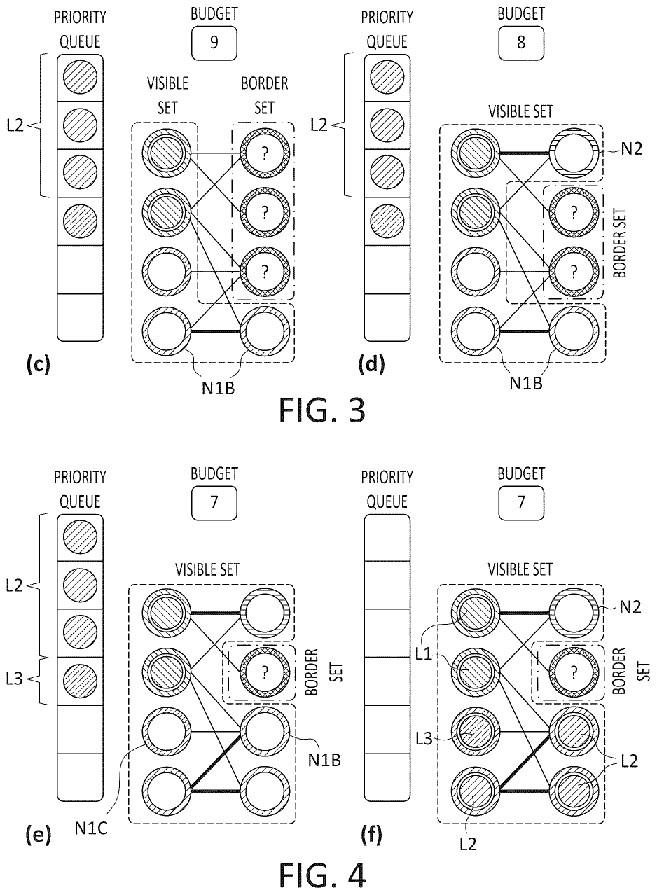

FIG. 2 illustrates aspects of the scenario just described. Note that the variously shaded elements L1, L2, L3, and L4 (FIG. 3d), represent labels and that available nodes such as the nodes N1 in the visible set of nodes, that is, nodes with no elements attributed yet, are unfilled larger circles while elements, including the examples referenced by E1, are filled smaller circles. Finally, nodes in border, such as the examples referenced by N2, have an unknown label and are therefore outlined with an interrogation mark. Thus, the example of FIG. 2 discloses an initial network graph with a priority queue and a budget, at part (a) of FIG. 2. In the first stage of one embodiment, the two highest priority elements L1 of the priority queue are attributed to the nodes N1A, as indicated at part (b) of FIG. 2.

With continued reference to the example of FIG. 2, after the initial state (a), the algorithm, according to one embodiment, extracts the highest priority elements L1 with the same label. These two elements L1 are then attributed to the two available nodes N1A in the visible set of nodes, as shown at (b). In this case, the algorithm did not need to perform a search since there was an adequate number of nodes, that is, N1A, to which the elements L1 could be assigned. As such, no change is made to the query budget and it remains at 10.

However, and as shown at (b) in FIG. 2, after extracting the next highest priority elements L2 of the same label, that is, the three top elements on the priority queue in (b), the algorithm may verify that there are not enough nodes N1B available in the visible set in (b) for assignment of the priority elements L2. That is, as shown at (b), there is only one node N1B, but three priority elements L2. FIG. 3 discloses the next stage in a method according to one embodiment. The reference designations in FIG. 2 are carried forward for the remaining stages of this example embodiment.

As shown in FIG. 2 at (b), there are now three priority elements L2, but only one node N1B. Thus, and with reference now to FIG. 3, an embodiment may apply an SH algorithm trained to find nodes N1B, as shown at (c) in FIG. 3, and this results in the identification of an additional node N1B, that is, additional to the node N1B shown in (b) of FIG. 2. This results in the decrementing of the query budget from 10 (part (b) in FIG. 2) to 9 (part (c) in FIG. 3). However, a further node N1B is still needed. Using a second query of the query budget, the algorithm makes a wrong prediction and queries a node N2, rather than N1B, as shown at (d) in FIG. 3. This results in a decrementing of the query budget from 9 to 8, as shown in FIG. 3 at (d). In an embodiment, the SH algorithms seek to reduce misses to avoid wasting budget. Because of the miss shown at (d) in FIG. 4, the algorithm still needs to find another N1B node, and is able to perform additional queries since the query budget has not yet been exhausted. This is depicted in the example of FIG. 4.

That is, since there is still query budget (8), and border nodes (2), available, an embodiment may apply the SH algorithm again in an attempt to identify a further N1B node. As shown at FIG. 4, part (e), a further N1B node has been identified as a result of application of the SH algorithm, which also results in a decrease in the query budget from 8 to 7. Now that three N1B nodes have been identified, the L2 elements can each be attributed to a respective N1B node, as shown in part (f) of FIG. 4. Similarly, the element L3 can be attributed by the SH algorithm to the node N1C that is already available in the visible set of nodes. At this point, all of the elements in the priority queue have been attributed to a respective node, and the SH algorithm may then halt, as shown in part (f) of FIG. 4.

While, in the illustrative example just discussed, the SH algorithm succeeded in attributing all of the elements of the priority queue to respective nodes, that may not always be the case. That is, the SH algorithm may, in some circumstances, fail to attribute all of the elements of the priority queue to respective nodes.

For example, reasons for a failure to attribute all of the elements of the priority queue to a node include exploring all unknown nodes and still not finding the right label. Another reason is depletion of the query budget while performing the node search(es). Either of these scenarios may be resolved by decreasing the priority of the elements, reorganizing the priority queue, and proceeding with the attribution of next elements on the priority queue whenever possible. Policies such as decreasing priority after spending too much budget after unsuccessfully finding a specific label can be devised and added to the proposal in one or more embodiments.

### D.1 Algorithm Choice

One or more example embodiments are agnostic to the particular SH graph search algorithm employed. Moreover, in one embodiment, more than one SH algorithm is employed. Also, an embodiment may employ an algorithm specialized in heterogeneous graphs such as MCrawl (see [2]) if the problem modeling requires a graph where nodes and edges have different meanings.

An example embodiment may use a simple algorithm, or any simple embodiment of D³TS algorithm with only a few machine learning models, such as in a scenario with constrained resources and time. More advanced versions of the D³TS (see [1]) can be employed in situations where there is plenty of query budget and the network is composed of hundreds of thousands of nodes. Algorithms that build statistical models may store historical data between each independent batch run and that may be considered in some embodiments. Since one embodiment may assume that the graph is highly dynamic, such an embodiment should account for ways to continually update such historical data of the graph, such as employing continual learning techniques (see [3]) for example.

### D.2 Multi-Label Nodes and Composite Elements

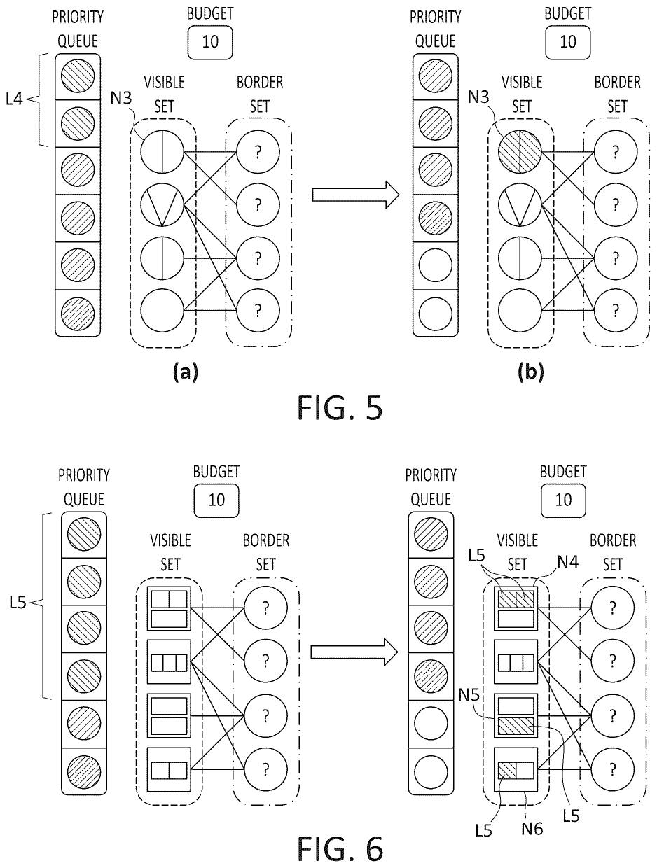

In one example embodiment, nodes can carry more than one label. That is, a node can accommodate more than one element. In an embodiment, this can be handled, for example, by the algorithm disclosed herein at C.2, particularly, by part 6.b of that algorithm, namely “. . . Verify if all the extracted elements can be placed in nodes on the visible set . . . ” where an embodiment needs to check for more than one node label available for nodes that can carry more than one element of the same type. FIG. 5 depicts an example embodiment of this variation.

More particularly, FIG. 5, at part (a), discloses an example of an initial network graph with a priority queue and a query budget. In the first step, that is, part (a), the two highest priority elements L4 are attributed to a single node N3 that can carry two elements, as shown at part (b) of FIG. 5. Note that, in an embodiment, nodes may carry more than a single element if those elements are all the same type. Thus, as shown in the example of FIG. 5 at part (b), the node N3 in the visible set of nodes can carry at most the two elements L4, as shown by the common shading scheme for N3 and L4.

In another example embodiment, a node may accommodate one or more elements from the same label, or from different respective labels. In such a case, an approach according to one embodiment is to include a list of slots available for each label in case in multiple labels, or a single list for a single label. If there are slots available for the search label being searched for, this node is then considered available. This approach is referred to herein as the ‘bucket variation,’ an example of which is disclosed in FIG. 6.

In particular, FIG. 6 discloses an example of an initial network graph with a priority queue and a budget (a) in the bucket variation. In part (a), the four highest priority elements L5 are attributed to three nodes N4, N5, and N6 that can carry those L5 elements, as shown at part (b). Note that these example nodes N4, N5, and N6 can carry more than a single element and more than one label of elements, as one node can have multiple containers for different labels, as indicated by the shading scheme, of elements.

An embodiment of the bucket variation disclosed in FIG. 6 comprises a modification to the algorithm originally presented in part C.2 above. The following modifications address this case in the search for nodes that have available slots. Assuming a naïve implementation in which the slots of a node are defined as separate lists for different labels, and further assuming that each node carries n lists, that is, there are n labels, with size k each, the worst-case scenario for looking for an empty slot is O(mk) assuming m is the size of the visible set.

In an embodiment, this may be improved by keeping a hash map of buckets by colors, or some other scheme, and the number of free slots in each of the buckets. Thus, instead of performing a linear search in each list for each element removed from PQ, an embodiment may find lists of buckets with the same label in a hash map entry. This additional hash map may be updated at each step of the SH algorithm as new slots become available.

A more complex embodiment may be adapted to a use-case in which workloads are not unitary elements but small graphs in which dependencies between the workloads are modelled as edges. This embodiment may employ a subgraph matching technique, such as in part 6.b. of the algorithm set forth at C.2, above.

Additionally, an embodiment may leverage conventional algorithms as presented in [4] as an alternative for subgraph matching search methods.

Finally, this can be generalized for the multi-label node case discussed earlier herein. The running time for such an embodiment should be considered, as general subgraph matching is computationally demanding.

### D.3 Distributed Aspects of an Example Embodiment

In one embodiment, an algorithm may be implemented in a distributed way where each embodiment, two or more semi-independent crawlers perform respective SH processes, in a possible overlapping part of the graph. To do so, some conditions must be met:
1. Crawlers must share the same set of labels; and
2. The node state must be visible to all crawlers, the node state refer to the label of the node, and availability information in each moment; and
3. Crawlers can be independent to choose new nodes to query if they have budget, but they can also share their border and visible sets.

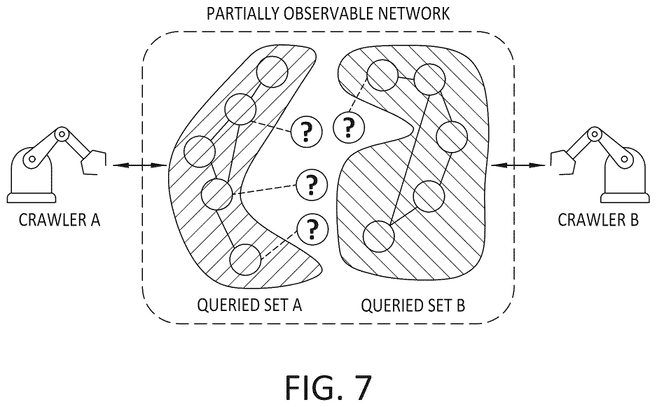

With attention now to FIG. 7, an example embodiment is disclosed in which two crawlers, namely, Crawler A and Crawler B, each having its own respective query budget, and performing independently of the other, perform respective SH processes in distinct non-overlapping parts of the same partially observable network, that is, Queried Set A and Queried Set B. A distributed embodiment such as the one in FIG. 7 may find applicability in large networks that are geographically distributed. By sharing the border and visible sets, the crawlers can make far better decisions, using the multiple instances of SH algorithms, as now more information is available than what would be possible by completely independent crawlers. This communication between the crawlers can be easily established especially if they are a few hops apart in the communication network.

### E. Example Use Cases for One or More Embodiments

Following are some example, but non-limiting, use cases for one or more embodiments.

### E.1 Workload Placement

In edge computing and multi-cloud architectures, a recurring problem is how to allocate workloads in an infrastructure network in the best possible way while considering the availability of the infrastructure nodes and the service level agreements (SLAs) fulfillment. Moreover, it is particularly important that, in as-a-service (aaS) scenarios, workloads are allocated in the shortest possible time, avoiding the creation of queues and ensuring that the execution result is also returned to the user in the shortest possible time. In this sense, performance, availability, and scalability are major challenges for workload placement strategies.

The workload placement problem can be mapped into a partially observed graph search problem over a graph-based infrastructure topology. Considering that each node and workload have a specific label, which means that a process may only attribute a workload in a node with the same label, an embodiment may be applied to search for multiple target labels (nodes) and at the same time attribute elements (workloads) to them. In this way, an embodiment may can improve performance, ensure availability while reducing latency and promote scalability in a workload placement scenario.

E.2 Topic search in social networks

Another example of an application for one or more embodiments is in the context of social networks. Considering the users as nodes, and friendship status, as edges, there is a list of topics, and there is a need to find users discussing one or more particular topics. In addition, access to the network is limited and it is impossible to query all nodes of the network. Since only a small set of users and their friendships are known, the problem becomes one of a search for multiple target labels (topics) in a partially observed graph. To this end, an embodiment may retrieve users discussing a specific or multiple topics. This is particularly relevant in applications where there is a need to collect high-quality massive databases to train, for instance, Large Language Models (LLM) models, but the process is confined to query limitations in APIs such X's (formerly Twitter) Firehose.

### F. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. Further Example Embodiments

Following are some further example embodiments. These are presented only by way of example and are not intended to limit the scope of this disclosure or the claims in any way.

Embodiment 1. A method, comprising: receiving an initial batch of elements; building a priority queue for the elements; building a graph that represents a network, and the graph comprises nodes, and edges connecting the nodes; using a seed set of nodes of the graph as an initial visible set of nodes, and the seed set is a subset of all nodes of the graph; and so long as elements remain in the priority queue and/or a query budget has not been exhausted, attributing the elements to the nodes of the graph.

Embodiment 2. The method as recited in claim 1, wherein the attributing of the elements to the nodes of the graph comprises part of an SH (selective harvesting) process.

Embodiment 3. The method as recited in claim 2, wherein the SH process is one of multiple SH processes used to attribute the elements to the graph.

Embodiment 4. The method as recited in claim 3, wherein each of the SH processes is performed by a respective crawler over a respective portion of the graph, and the respective portions of the graph either overlap with each other, or do not overlap with each other.

Embodiment 5. The method as recited in claim 1, wherein attribution of the elements to the nodes is based on one or more labels respectively carried by each of the nodes.

Embodiment 6. The method as recited in claim 1, wherein the elements comprise respective computing workloads assigned to the nodes.

Embodiment 7. The method as recited in claim 1, wherein the priority queue indicates a relative priority of each of the elements to the other elements.

Embodiment 8. The method as recited in claim 1, wherein the query budget is decremented by 1 each time a search of the graph is performed that is unsuccessful in identifying a node to which one of the elements can be attributed.

Embodiment 9. The method as recited in claim 1, wherein one of the elements is attributed to one of the nodes based on performance of an SH (selective harvesting) process that identified that node from either a visible set of nodes, or a border set of nodes.

Embodiment 10. The method as recited in claim 9, wherein the SH process is performed when the elements cannot all be attributed to the nodes, and the visible set and the border set are updated after completion of the SH process.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

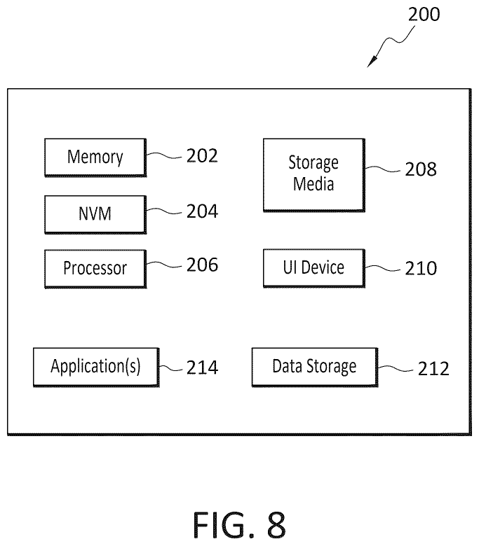

With reference briefly now to FIG. 8, any one or more of the entities disclosed, or implied, by FIGS. 1-7, and/or elsewhere herein, may take the form of, or include, or be implemented on, or hosted by, a physical computing device, one example of which is denoted at 200. As well, where any of the aforementioned elements comprise or consist of a virtual machine (VM), that VM may constitute a virtualization of any combination of the physical components disclosed in FIG. 8.

In the example of FIG. 8, the physical computing device 200 includes a memory 202 which may include one, some, or all, of random access memory (RAM), non-volatile memory (NVM) 204 such as NVRAM for example, read-only memory (ROM), and persistent memory, one or more hardware processors 206, non-transitory storage media 208, UI device 210, and data storage 212. One or more of the memory components 202 of the physical computing device 200 may take the form of solid state device (SSD) storage. As well, one or more applications 214 may be provided that comprise instructions executable by one or more hardware processors 206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving an initial batch of elements;
building a priority queue for the elements;
building a graph that represents a network, and the graph comprises nodes, and edges connecting the nodes;
using a seed set of nodes of the graph as an initial visible set of nodes, and the seed set is a subset of all nodes of the graph; and
so long as elements remain in the priority queue and/or a query budget has not been exhausted, attributing the elements to the nodes of the graph.

2. The method as recited in claim 1, wherein the attributing of the elements to the nodes of the graph comprises part of an SH (selective harvesting) process.

3. The method as recited in claim 2, wherein the SH process is one of multiple SH processes used to attribute the elements to the graph.

4. The method as recited in claim 3, wherein each of the SH processes is performed by a respective crawler over a respective portion of the graph, and the respective portions of the graph either overlap with each other, or do not overlap with each other.

5. The method as recited in claim 1, wherein attribution of the elements to the nodes is based on one or more labels respectively carried by each of the nodes.

6. The method as recited in claim 1, wherein the elements comprise respective computing workloads assigned to the nodes.

7. The method as recited in claim 1, wherein the priority queue indicates a relative priority of each of the elements to the other elements.

8. The method as recited in claim 1, wherein the query budget is decremented by 1 each time a search of the graph is performed that is unsuccessful in identifying a node to which one of the elements can be attributed.

9. The method as recited in claim 1, wherein one of the elements is attributed to one of the nodes based on performance of an SH (selective harvesting) process that identified that node from either a visible set of nodes, or a border set of nodes.

10. The method as recited in claim 9, wherein the SH process is performed when the elements cannot all be attributed to the nodes, and the visible set and the border set are updated after completion of the SH process.

11. A non-transitory storage medium having stored therein instructions that are executable by one or more hardware processors to perform operations comprising:
receiving an initial batch of elements;
building a priority queue for the elements;
building a graph that represents a network, and the graph comprises nodes, and edges connecting the nodes;
using a seed set of nodes of the graph as an initial visible set of nodes, and the seed set is a subset of all nodes of the graph; and
so long as elements remain in the priority queue and/or a query budget has not been exhausted, attributing the elements to the nodes of the graph.

12. The non-transitory storage medium as recited in claim 11, wherein the attributing of the elements to the nodes of the graph comprises part of an SH (selective harvesting) process.

13. The non-transitory storage medium as recited in claim 12, wherein the SH process is one of multiple SH processes used to attribute the elements to the graph.

14. The non-transitory storage medium as recited in claim 13, wherein each of the SH processes is performed by a respective crawler over a respective portion of the graph, and the respective portions of the graph either overlap with each other, or do not overlap with each other.

15. The non-transitory storage medium as recited in claim 11, wherein attribution of the elements to the nodes is based on one or more labels respectively carried by each of the nodes.

16. The non-transitory storage medium as recited in claim 11, wherein the elements comprise respective computing workloads assigned to the nodes.

17. The non-transitory storage medium as recited in claim 11, wherein the priority queue indicates a relative priority of each of the elements to the other elements.

18. The non-transitory storage medium as recited in claim 11, wherein the query budget is decremented by 1 each time a search of the graph is performed that is unsuccessful in identifying a node to which one of the elements can be attributed.

19. The non-transitory storage medium as recited in claim 11, wherein one of the elements is attributed to one of the nodes based on performance of an SH (selective harvesting) process that identified that node from either a visible set of nodes, or a border set of nodes.

20. The non-transitory storage medium as recited in claim 19, wherein the SH process is performed when the elements cannot all be attributed to the nodes, and the visible set and the border set are updated after completion of the SH process.
